(19) United States
(12) Patent Application Publication
(10) Pub. No.: US 2026/0027687 A1
(43) Pub. Date: Jan. 29, 2026

(54) NAIL EXTRACTION ATTACHMENT FOR NAIL GUN

(71) Applicant: Cody Michael Hughes, Cochrane (CA)

(72) Inventor: Cody Michael Hughes, Cochrane (CA)

(21) Appl. No.: 18/780,615

(22) Filed: Jul. 23, 2024

(51) Int. Cl. B25C 11/00

(52) U.S. Cl. CPC B25C 11/00

(57) ABSTRACT

A nail extraction device configured to be operably coupled to a nail gun wherein the device of the present invention is operable to facilitate the removal of nails from a material wherein the nails have an exposed end. The invention includes a body having a first end and second end with a mounting plate member being present at the first end of the body. A tube member is contiguously formed with the mounting plate member having a first opening and second opening located at distal ends thereof and having a hollow passage therebetween. The tube member has a first portion and a second portion contiguously formed with the first portion being tapered in shape reducing in diameter. An extraction pin member is movably mounted within the hollow passage of the tube member. The extraction pin member is configured to be engaged by a hammer pin of a nail gun.

### FIELD OF THE INVENTION

The present invention relates generally to construction tools, more specifically but not by way of limitation, a device configured to be operably coupled to a nail gun wherein the device is operable to engage a protruding end point of a nail and facilitate removal of the nail from wood or other material.

### BACKGROUND

Nails have been utilized for many decades in the construction industry to fasten one object to another. Common applications for nail utilization includes applications such as but not limited to framing, roofing and laying of subfloor. While traditional hammers are still employed, most construction workers employ nail guns due to speed and efficiency. Nail guns are most commonly powered by either a battery source or a pneumatic source and are capable of driving a multitude of nails into wood or other materials per minute.

Nail construction has been unchanged and consists of a head end having a flat surface operable to be engaged by a hammer along with a distal end having a point configured to be driven into a suitable material. There are instances wherein a nail must be extracted from a material due to the point end of the nail being in a condition where the point end is extending beyond the surface of the material. This can occur for many reasons and the nail most often is desired to be removed either for safety reasons or construction integrity. A common technique to remove the protruding nail is to use a claw hammer and engage the head end of the nail applying leverage thereto in order to facilitate removal. While this technique can be effective, there are occasions where the head of the nail is not accessible with a claw hammer or similar device. Additionally, this technique is typically not accomplished with speed or efficiency.

Accordingly, there is a need for a device that can be attached to a nail gun wherein the device is constructed to engage an exposed point end of a nail and engage therewith so as to facilitate extraction of the nail from the material in which the nail is embedded.

### SUMMARY OF THE INVENTION

It is the object of the present invention to provide a device that is configured to be operably coupled to a nail gun wherein the present invention includes a body having a first end and a second end.

Another object of the present invention is to provide a nail extraction device configured to be operably coupled to a nail gun wherein the first end of the body includes a mounting plate member.

A further object of the present invention is to provide a device that is configured to be operably coupled to a nail gun wherein the mounting plate member is configured to be operably coupled to a nail gun proximate a firing pin and nose area of the nail gun.

Yet a further object of the present invention is to provide a nail extraction device configured to be operably coupled to a nail gun wherein the body includes a tube member contiguously formed with the mounting plate extending outward therefrom.

Still another object of the present invention is to provide a device that is configured to be operably coupled to a nail gun wherein the tube member has a first portion and a second portion.

An additional object of the present invention is to provide a nail extraction device configured to be operably coupled to a nail gun wherein the tube member has an extraction pin member movably disposed therein.

Yet a further object of the present invention is to provide a device that is configured to be operably coupled to a nail gun wherein the extraction pin member is configured to be operably engaged by the hammer pin of the nail gun and traverse within the tube member to engage a nail end point that is surroundably mounted by the distal end of the tube member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the present invention; and

FIG. 1A is a detailed view of a nose area of a conventional nail gun; and

FIG. 2 is a cross-sectional view of the tube member of the present invention; and

FIG. 3 is a cross-section view of the present invention; and

FIG. 4 is a top view of the present invention; and

FIG. 5 is a side perspective view of the present invention; and

FIG. 6 is a side view of the present invention.

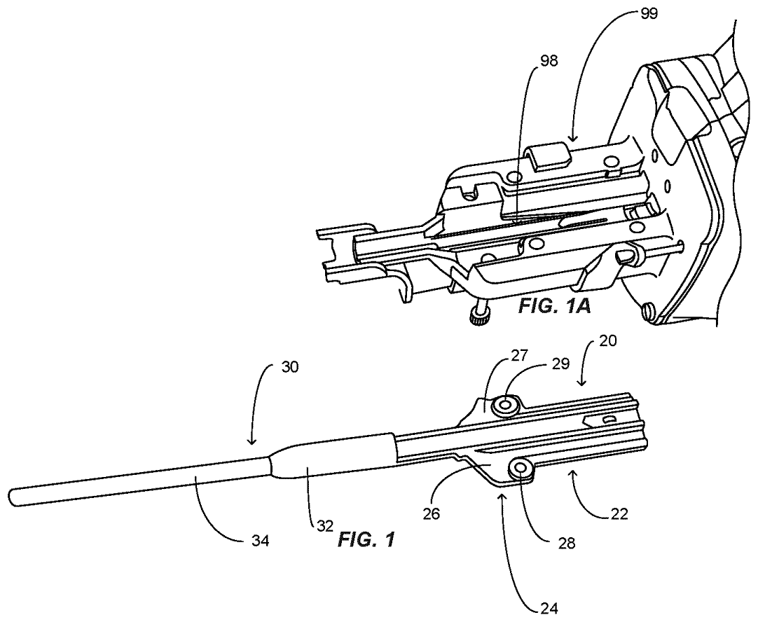

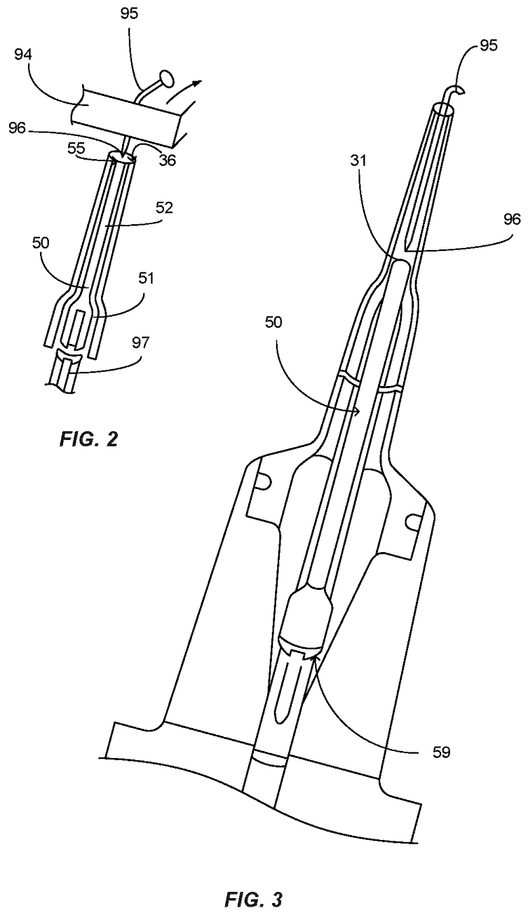

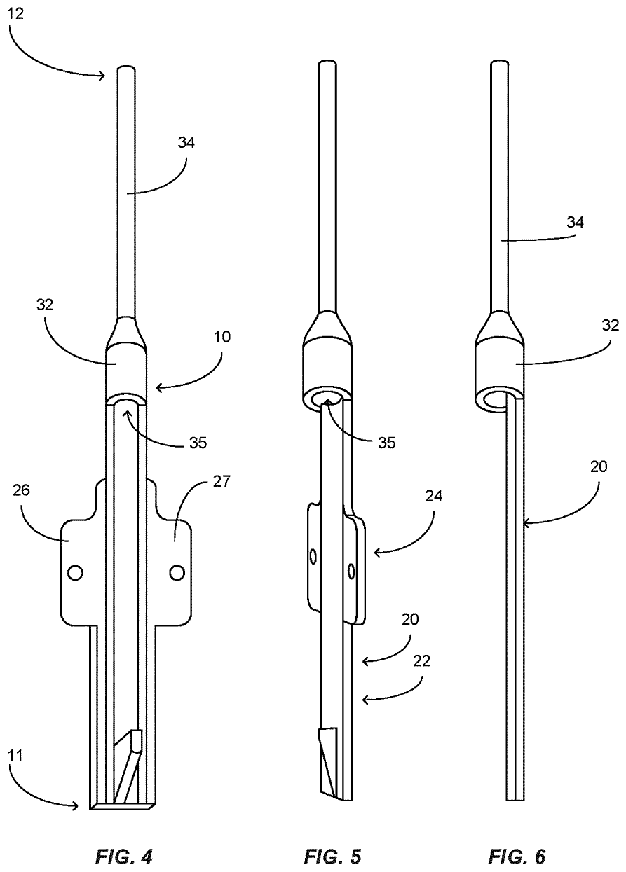

### DETAILED DESCRIPTION

Referring now to the drawings submitted herewith, wherein various elements depicted therein are not necessarily drawn to scale and wherein through the views and figures like elements are referenced with identical reference numerals, there is illustrated a nail extraction device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the nail extraction device 100 includes a body 10 that is manufactured from a durable rigid material such as but not limited to metal. It should be understood within the scope of the present invention that the body 10 could be manufactured in alternate sizes so as to accommodate various commercially available brands of nail guns. It should further be understood within the scope of the present invention that the nail extraction device 100 is configured to be operably coupled to both pneumatic and battery powered nail guns.

The body 10 includes a mounting plate member 20 proximate the first end 11 thereof. The mounting plate member 20 is planar in manner having a first portion 22 and second portion 24 that are contiguously formed. The first portion 22 has a consistent width across the length thereof. Second portion 24 includes wing members 26,27 that have a width greater than that of the first portion 22. Wing members 26, 27 further have bored therethrough apertures 28,29. The mounting plate member 20 is mateably shaped so as to be secured into the receiving slot 98 of the exemplary nose area 99 of a conventional nail gun. Fasteners, such as but not limited to screws are journaled through the apertures 28,29 facilitating the securing of the mounting plate member 20 into the receiving slot 98. It should be understood within the scope of the present invention that the shape of the mounting plate member 20 described and illustrated herein is to accommodate a particular commercial brand of nail gun. It is contemplated within the scope of the present invention that the mounting plate member 20 could be provided in alternate shapes so as to mateably couple with alternate brands of nail guns.

Contiguously formed with the mounting plate member 20 is the tube member 30. The tube member 30 includes a first portion 32 and a second portion 34 and is hollow having a first opening 35 and second opening 36. The first portion 32 of the tube member 30 is tapered in shape having a diameter that is larger proximate first opening 35. The first portion 32 diminishes in diameter progressively towards the second portion 34. The tapered shape of the first portion 32 is operable to inhibit forward travel past the first portion 32 of the extraction pin member 50 during movement thereof. The second portion 34 of the tube member 30 is cylindrical in shape having a consistent diameter the length thereof.

The extraction pin member 50 is movably mounted within the tube member 30. Extraction pin member 50 is mateably shaped with the tube member 30 having similarly shaped first portion 51 and second portion 52. The extraction pin member 50 is configured to traverse in a forwards-backwards movement within the tube member 30. First portion 51 of the extraction pin member 50 is engaged by the hammer pin 97 of a conventional nail gun. Subsequent engagement of the first portion 51 by the hammer pin 97 the extraction pin member 50 traverses within the tube member 30 facilitating engagement of the second end 55 with nail end 96. The opening 36 is surroundably present around the nail end 96 and engagement with the second end 55 applies sufficient force to remove the nail 95 from material 94. It should be understood within the scope of the present invention that opening 36 can be utilized to surround the nail 95 with second portion 34 of tube member 30 being further employed to apply leverage to the nail 95 so as to provide straightening thereof prior to firing of the hammer pin 97. It is contemplated within the scope of the present invention that the extraction pin member 50 could be manufactured in alternate sizes in order to achieve the desired objective discussed herein.

It should be further understood within the scope of the present invention that the second end 31 could be concave in shape to facilitate improved engagement with the nail end 96. Furthermore, in a preferred embodiment of the present invention the end 59 is planar and blunt in form so as to facilitate the desired engagement with the hammer pin 97. It should be further understood within the scope of the present invention that during operational movement of the extraction pin member 50, the second end 31 traverses so as to be generally adjacent opening 36.

While the above description is directed to the removal of nails in operation with a nail gun, it is to be understood that the mechanism and method may also be similarly applied to the extraction of screws in the same manner, where applicable.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A nail extraction device configured to be operably coupled to a nail gun wherein the nail extraction device comprises:
a body, said body having a first end and a second end, said body having a mounting plate member proximate said first end, said mounting plate member being planar in manner, said body further having a tube member, said tube member being contiguously formed with said mounting plate member, said tube member having a first opening and a second opening located at distal ends thereof, said tube member having a hollow passage intermediate said first opening and said second opening; and
an extraction pin member, said extraction pin member being movably mounted within said hollow passage of said tube member, said extraction pin member having a first end and a second end, said second end of said extraction pin member configured to strike an exposed nail end of a nail to facilitate removal of the nail.

2. The nail extraction device configured to be operably coupled to a nail gun as recited in claim 1, wherein said mounting plate further includes a first portion and a second portion, said first portion of said mounting plate having a width less than that of a width of said second portion of said mounting plate.

3. The nail extraction device configured to be operably coupled to a nail gun as recited in claim 2, wherein said tube member includes a first portion and a second portion, said first portion of said tube member being tapered in shape.

4. The nail extraction device configured to be operably coupled to a nail gun as recited in claim 3, wherein said second portion of said tube member is cylindrical in shape.

5. The nail extraction device configured to be operably coupled to a nail gun as recited in claim 4, wherein said extraction pin member includes a first end and a second end, said second end being concave in shape.

6. The nail extraction device configured to be operably coupled to a nail gun as recited in claim 5, wherein said second portion of said mounting plate member includes a first wing member and a second wing member, said first wing member and said second wing member being on opposing sides of said mounting plate member.

7. The nail extraction device configured to be operably coupled to a nail gun as recited in claim 6, wherein said first wing member and said second wing member have an aperture formed therein.

8. The nail extraction device configured to be operably coupled to a nail gun as recited in claim 7, wherein said first portion of said tube member is tapered in shape having a diameter that reduces progressively towards said second portion of said tube member.

9. The nail extraction device configured to be operably coupled to a nail gun as recited in claim 8, wherein said first end of said extraction pin member is blunt in shape, said first end of said extraction pin member configured to be engaged by a hammer pin of a nail gun.

10. The nail extraction device configured to be operably coupled to a nail gun as recited in claim 9, wherein said second opening of said tube member is configured to surroundably mount the nail end.
